(19) United States
(12) Patent Application Publication
(10) Pub. No.: US 2010/0126292 A1
(43) Pub. Date: May 27, 2010

(54) Deflector for ball screw device

(75) Inventor: Chung Hsueh Lin, Taichung (TW)

Correspondence Address: CHARLES E. BAXLEY, ESQUIRE, 90 JOHN STREET, SUITE 309, NEW YORK, NY, 10038, US

(73) Assignee: Hiwin Technologies Corp.

(21) Appl. No.: 12/315,096

(22) Filed: Nov. 25, 2008

(51) Int. Cl. F16H 25/06

(52) U.S. Cl. 74/424.87

(57) ABSTRACT

A ball screw device includes a screw engaged into a nut member for forming an endless ball guiding passage between the nut member and the screw and for receiving a number of ball bearing members, a deflector includes a deflector member engaged into the nut member and having an upwardly extended ridge engaged with a recess of the nut member to position the deflector member to the nut member and to prevent the deflector member from deviating relative to the nut member, and a fastener is secured to the nut member to force the ridge of the deflector member to solidly engage with the recess of the nut member and to suitably anchor or position the deflector to the nut member.

### BACKGROUND OF THE INVENTION

1. Field of the Invention

The present invention relates to a ball deflector for a ball screw device, and more particularly to a ball deflector including an anchoring or positioning structure or device for suitably anchoring or positioning the ball deflector to the ball screw device and for preventing the ball deflector from being tilted or deviated relative to the ball screw device and for suitably guiding the ball bearing members to smoothly move through the endless ball guiding passages of the ball screw device.

2. Description of the Prior Art

Typical ball screw devices comprise a nut threaded onto an elongated bolt or screw and rotatable and movable or adjustable along the screw, one or more endless ball guiding passages formed in the ball screw device for slidably receiving ball bearing members, and one or more ball deflectors engaged into the endless ball guiding passages of the ball screw device for guiding the ball bearing members to smoothly move through the endless ball guiding passages of the ball screw device.

For example, U.S. Pat. No. 3,661,030 to Gagne discloses one of the typical ball screw and nut combinations also comprising a ball deflector engaged into an endless ball guiding passage of the ball screw and nut combination for guiding the ball bearing members to smoothly move through the endless ball guiding passage of the ball screw and nut combination.

However, it will be difficult to precisely form and shape the ball deflector and to precisely assemble and retain the ball deflector within the endless ball guiding passage of the ball screw and nut combination during assembly and/or while working such that the ball deflector may have a good chance to be tilted or deviated relative to the ball screw and nut combination and such that the ball bearing members may not be guided to smoothly and suitably move through the endless ball guiding passage of the ball screw and nut combination after use.

U.S. Pat. No. 5,014,568 to Schlenker discloses another typical ball screw and nut assembly also comprising a ball deflector engaged into an endless ball guiding passage of the ball screw and nut assembly for guiding the ball bearing members to smoothly move through the endless ball guiding passage of the ball screw and nut assembly, and pairs of adjustable locator bosses situated at opposite ends of the elongated body of the ball deflector and symmetrically positioned on the upper body in adjacent quadrants of the upper body.

However, the pairs of adjustable locator bosses are situated at the side portions of the opposite ends of the elongated body of the ball deflector and may not precisely retain the ball deflector within the endless ball guiding passage of the ball screw and nut assembly during assembly and/or while working when the elongated body of the ball deflector is secured to the nut with an upwardly extended threaded stem.

U.S. Pat. No. 7,234,368 to Lin et al. of the present applicant discloses a further typical ball screw device also comprising one or more ball deflectors engaged into the endless ball guiding passage of the ball screw device for guiding the ball bearing members to smoothly move through the endless ball guiding passage of the ball screw device.

However, similarly, the ball deflectors also may not be precisely formed and shaped and may not be precisely assembled and retained within the endless ball guiding passage of the ball screw and nut combination during assembly and/or while working such that the ball deflector may have a good chance to be tilted or deviated relative to the ball screw device and such that the ball bearing members may not be guided to smoothly and suitably move through the endless ball guiding passage of the ball screw device after use.

The present invention has arisen to mitigate and/or obviate the afore-described disadvantages of the conventional ball deflectors for the ball screw devices.

### SUMMARY OF THE INVENTION

The primary objective of the present invention is to provide a deflector including an anchoring or positioning structure or device for suitably anchoring or positioning the ball deflector to the ball screw device and for preventing the ball deflector from being tilted or deviated relative to the ball screw device and for suitably guiding the ball bearing members to smoothly move through the endless ball guiding passages of the ball screw device.

In accordance with one aspect of the invention, there is provided a ball screw device comprising a nut member including a screw hole formed therein and defined by a number of helical grooves, and including an aperture formed in the nut member and communicating with one of the helical grooves of the nut member, and including a recess formed in the nut member and communicating with the helical groove of the nut member, an elongated screw engaged into the screw hole of the nut member and including a number of helical grooves for engaging with the helical grooves of the nut member and for forming an endless ball guiding passage between the nut member and the screw, a number of ball bearing members engaged in the endless ball guiding passage of the ball screw device, and a deflector including a deflector member engaged into the helical groove of the nut member, and including a ridge extended upwardly from the deflector member and engaged with the recess of the nut member to position the deflector member to the nut member and to prevent the deflector member from deviating relative to the nut member, and including a fastener engaged through the aperture of the nut member and secured to the nut member to force the deflector member to move upwardly toward the nut member and to force the ridge of the deflector member to engage with the recess of the nut member.

The fastener is extended from a middle portion of the deflector member and formed integral with the deflector member, and the fastener is engaged through the aperture of the nut member and engaged with a lock nut. Alternatively, the fastener may also be threaded or engaged with a screw hole of the deflector member.

The ridge is preferably an elongated ridge extended upwardly from the deflector member. The recess of the nut member is preferably a curved recess, or a helical recess.

The nut member includes two orifices formed in the nut member and communicating with the helical groove of the nut member, and includes a ball return pipe having two ends engaged into the orifices of the nut member and having a ball return pathway formed in the ball return pipe and communicating with the helical groove of the nut member for receiving the ball bearing members.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a cross sectional view of a ball screw device including a ball deflector in accordance with the present invention;

FIG. 2 is an enlarged partial cross sectional view of the ball screw device;

FIG. 3 is a perspective view of the ball deflector;

FIG. 4 is a cross sectional view illustrating the other arrangement of the ball deflector and the ball screw device; and

FIG. 5 is a perspective view illustrating the ball deflector for the ball screw device as shown in FIG. 4.

### DETAILED DESCRIPTION OF THE PREFERRED EMBODIMENT

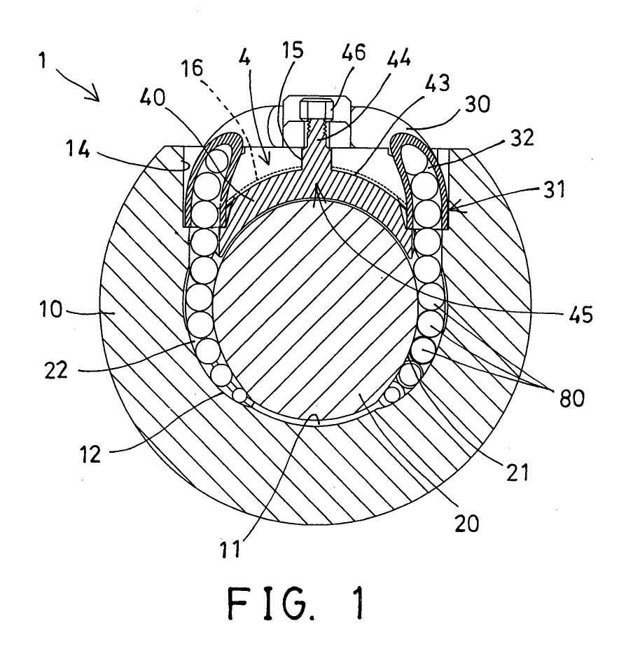

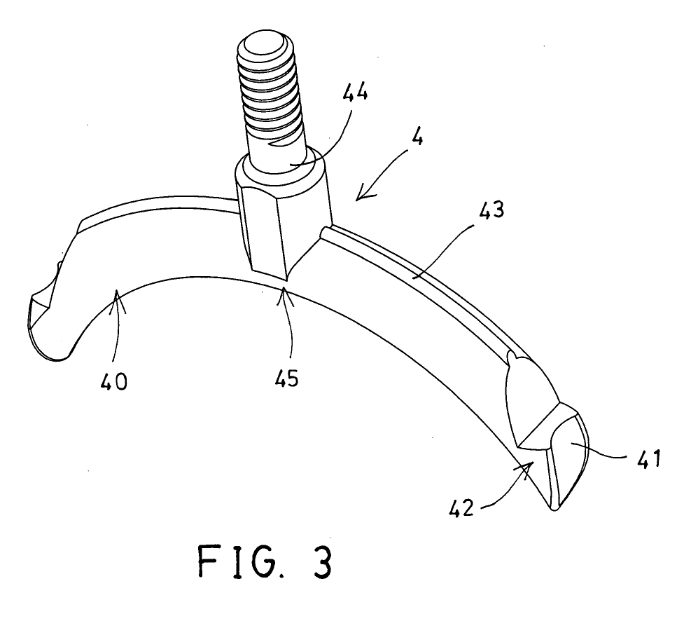

Referring to the drawings, and initially to FIGS. 1-3, a ball screw device 1 in accordance with the present invention comprises a nut member 10 including a screw hole 11 formed therein and formed or defined by a number of helical threaded portions or grooves 12, and an elongated bolt or screw 20 engaged into the screw hole 11 of the nut member 10 and including a number of helical threaded portions or grooves 21 for threading or engaging with the helical threaded portions or grooves 12 of the nut member 10 and for allowing the nut member 10 to be rotated and moved or adjusted along the screw 20, and for forming one or more endless ball guiding passages 22 in the ball screw device 1 or between the nut member 10 and the screw 20 and for slidably receiving a number of ball bearing members 80.

The nut member 10 includes one or more pairs of orifices 14 formed in the nut member 10 and communicating with the helical grooves 12 of the nut member 10, and includes one or more apertures 15 formed in the nut member 10 and also communicating with the helical grooves 12 of the nut member 10, and includes a curved or helical recess 16 formed in the nut member 10 and communicating with either of the helical grooves 12 of the nut member 10. One or more ball return pipes 30 each include two ends 31 engaged into the orifices 14 of the nut member 10, and each include a ball return pathway 32 formed therein and communicating with the helical grooves 12 of the nut member 10 and/or communicating with the endless ball guiding passages 22 of the ball screw device 1. The coupling structure of the ball return pipes 30 to the nut member 10 and the screw 20 is typical and will not be described in further details.

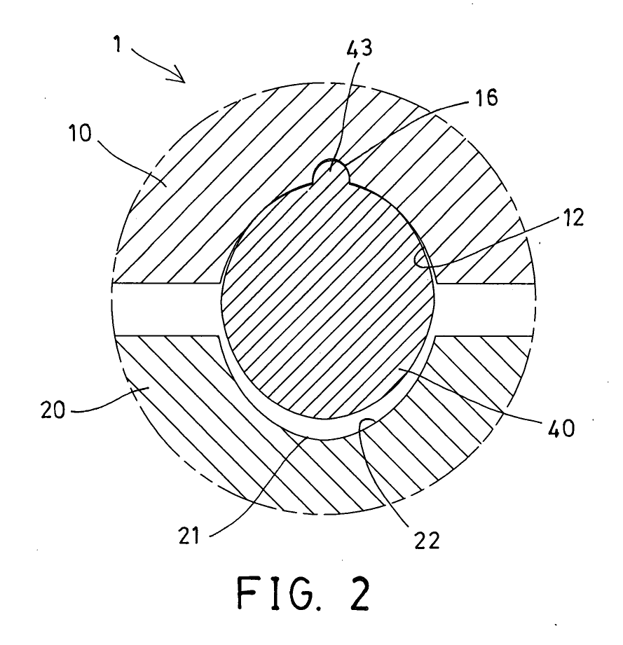

The ball screw device 1 further includes one or more ball deflectors 4 each having an elongated body or deflector member 40 engaged into the endless ball guiding passages 22 of the ball screw device 1 for guiding the ball bearing members 80 to smoothly move through the endless ball guiding passages 22 of the ball screw device 1, the deflector member 40 includes a curved depression 41 formed in each of the two end portions 42 thereof for engaging with and for guiding the ball bearing members 80 to smoothly move into the endless ball guiding passages 22 of the ball screw device 1, and includes a curved or elongated ridge 43 extended upwardly from the deflector member 40 for engaging with the helical recess 16 of the nut member 10 (FIG. 2) and for suitably anchoring or positioning the deflector member 40 to the nut member 10 of the ball screw device 1 and for preventing the deflector member 40 from being tilted or deviated relative to the nut member 10 of the ball screw device 1.

The deflector 4 further includes a fastener 44 attached or secured to the middle portion 45 of the deflector member 40, or extended from the middle portion 45 of the deflector member 40 and formed integral with the deflector member 40, and engaged through the aperture 15 of the nut member 10 and engaged with a lock nut 46 for solidly securing the deflector member 40 of the deflector 4 to the nut member 10. As shown in FIG. 1, when the deflector member 40 is secured to the nut member 10, the deflector member 40 may be forced to move upwardly relative to the nut member 10, and the ridge 43 of the deflector member 40 may also be moved upwardly to solidly engage with the helical recess 16 of the nut member 10 (FIG. 2) and to suitably anchor or position the deflector member 40 to the nut member 10 and to prevent the deflector member 40 from being tilted or deviated relative to the nut member 10 of the ball screw device 1.

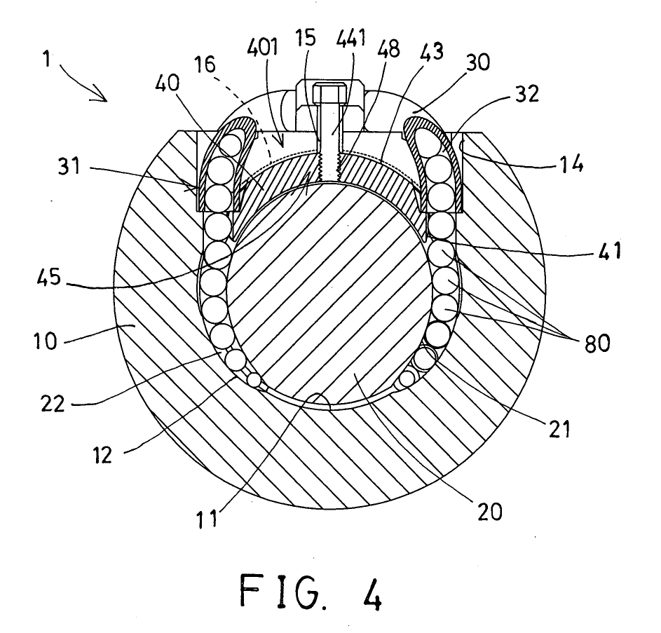

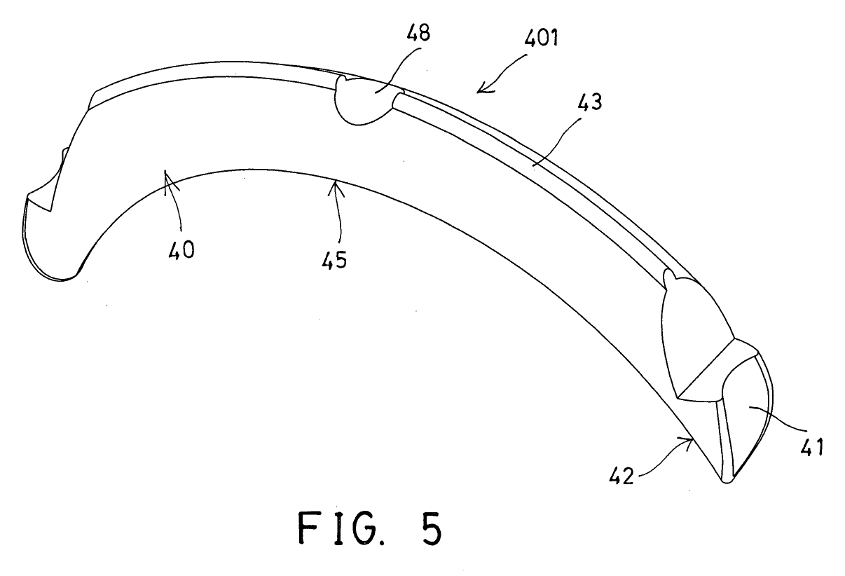

Alternatively, as shown in FIGS. 4-5, the deflector 4 may include a screw hole 48 formed in the middle portion 45 of the deflector member 40, and a fastener 441 may be engaged through the aperture 15 of the nut member 10 and threaded or engaged with the screw hole 48 of the deflector member 40 for solidly securing the deflector member 40 of the deflector 401 to the nut member 10 and for preventing the deflector member 40 of the deflector 401 from being tilted or deviated relative to the nut member 10 of the ball screw device 1. It is to be noted that the ridge 43 of the deflector member 40 may be forced to move upwardly and to solidly engage with the helical recess 16 of the nut member 10 and to suitably anchor or position the deflector member 40 to the nut member 10 when the deflector member 40 is forced to move upwardly relative to the nut member 10 and when the deflector member 40 is secured to the nut member 10 with the fastener 44, 441, best shown in FIGS. 1 and 4.

Accordingly, the deflector in accordance with the present invention includes an anchoring or positioning structure or device for suitably anchoring or positioning the ball deflector to the ball screw device and for preventing the ball deflector from being tilted or deviated relative to the ball screw device and for suitably guiding the ball bearing members to smoothly move through the endless ball guiding passages of the ball screw device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A ball screw device comprising:
a nut member including a screw hole formed therein and defined by a plurality of helical grooves, and including an aperture formed in said nut member and communicating with one of said helical grooves of said nut member, and including a recess formed in said nut member and communicating with said helical groove of said nut member,
an elongated screw engaged into said screw hole of said nut member and including a plurality of helical grooves for engaging with said helical grooves of said nut member and for forming an endless ball guiding passage between said nut member and said screw,
a plurality of ball bearing members engaged in said endless ball guiding passage of said ball screw device, and
a deflector including a deflector member engaged into said helical groove of said nut member, and including a ridge extended upwardly from said deflector member and engaged with said recess of said nut member to position said deflector member to said nut member and to prevent said deflector member from deviating relative to said nut member, and including a fastener engaged through said aperture of said nut member and secured to said nut member to force said deflector member to move upwardly toward said nut member and to force said ridge of said deflector member to engage with said recess of said nut member.

2. The ball screw device as claimed in claim 1, wherein said fastener is extended from a middle portion of said deflector member and formed integral with said deflector member.

3. The ball screw device as claimed in claim 1, wherein said fastener is engaged through said aperture of said nut member and engaged with a lock nut.

4. The ball screw device as claimed in claim 1, wherein said ridge is an elongated ridge extended upwardly from said deflector member.

5. The ball screw device as claimed in claim 1, wherein said recess of said nut member is a curved recess.

6. The ball screw device as claimed in claim 1, wherein said recess of said nut member is a helical recess.

7. The ball screw device as claimed in claim 1, wherein said nut member includes two orifices formed in said nut member and communicating with said helical groove of said nut member, and includes a ball return pipe having two ends engaged into said orifices of said nut member and having a ball return pathway formed in said ball return pipe and communicating with said helical groove of said nut member for receiving said ball bearing members.
